(19) United States
(12) Patent Application Publication
(10) Pub. No.: US 2011/0132988 A1
(43) Pub. Date: Jun. 9, 2011

(54) NON-CONTACT ELECTRONIC DEVICE

(75) Inventor: Kazuki Watanabe, Hino (JP)

(73) Assignee: Renesas Electronics Corporation

(21) Appl. No.: 13/056,703

(22) PCT Filed: Jul. 24, 2009
(86) PCT No.: PCT/JP2009/003495

§ 371 Date: Jan. 31, 2011

(30) Foreign Application Priority Data
Jul. 31, 2008 (JP) 2008197904

(51) Int. Cl. G06K 19/077

(52) U.S. Cl. 235/492

(57) ABSTRACT

A non-contact electronic device wherein variation in resonance frequency due to mutual interference between coils provided in individual IC cards can be suppressed and the housing thereof can be easily reduced in thickness is provided. The non-contact electronic device include: a substrate; a first coil for antenna arranged in the substrate; a semiconductor integrated circuit device that is arranged in the substrate and carries out non-contact interface between it and an external source utilizing the first coil; and a second coil comprising a resonance circuit together with the first coil and shielded from electromagnetic waves. Even when multiple non-contact electronic devices are simultaneously used, it is possible to suppress variation in resonance frequency due to mutual interference between the coils provided in individual non-contact electronic devices. Thus stable data communication can be achieved without significant degradation in communication distance regardless of the number of non-contact electronic devices.

### FIELD OF THE INVENTION

The present invention relates to non-contact electronic devices that communicate information between them and such devices as reader-writer devices and in particular to a technology effectively applicable mainly to wireless systems in which multiple non-contact electronic devices can be simultaneously used.

### BACKGROUND OF THE INVENTION

The non-contact electronic devices are provided therein with a semiconductor integrated circuit device and a coil. They exchanges information between, for example, an external reader-writer device and their semiconductor integrated circuit device and implement various functions including: transmitting data held in the relevant non-contact electronic device and holding data transmitted from a reader-writer device. The non-contact electronic devices are represented by IC cards and IC tags. In the description in this document, an IC card will be taken as a representative example and a non-contact electronic device will be hereafter also referred to as IC card.

Specific description will be given. The semiconductor integrated circuit device embedded in a non-contact electronic device does not incorporate a power source. Therefore, it receives high-frequency signals supplied from a reader-writer device at its coil and generates internal voltage required for its internal circuit from the high-frequency signals. A high-frequency signal is formed of a carrier wave and an information signal superimposed on the carrier wave. An information signal superimposed on a carrier wave is demodulated and processing is carried out according to the information signal. The result of the processing is superimposed on a carrier wave and data is thereby transmitted to the reader-writer device.

Wireless systems that enable this data communication between a reader-writer device and an IC card are capable of wirelessly reading data stored in the IC card from the reader-writer device and writing data to the IC card. Therefore, they are utilized in such as managing entering and leaving to and from a room, commodity management in shipping storages or the like.

In data transmission from a reader-writer device to an IC card, so-called down communication, an amplitude shift keying scheme (ASK scheme) in which the amplitude of each high-frequency signal is varied is often used. In data transmission from an IC card to a reader-writer device, so-called up communication, a load modulation scheme in which the load between both the ends of a coil provided in an IC card is varied is often used.

For example, the down communication means described in Non-patent Document 1 is an information communication means based on so-called amplitude shift keying in which the amplitude of each high-frequency alternating-current signal is partially modulated by down data. The down communication data is coded by Manchester coding. The up communication means is an information communication means based on a so-called load modulation scheme in which a load coupled to an antenna coil provided in an IC card is partially varied by up data. Similarly to the down communication data, the up communication data is coded by Manchester coding.

For example, the down communication means described in Non-patent Document 2 is an information communication means based on so-called amplitude shift keying in which the amplitude of each high-frequency alternating-current signal is partially modulated by down communication data. The down communication data is coded by NRZ-L or the like. The up communication means is an information communication means based on a so-called load modulation scheme in which a load coupled to an antenna coil provided in an IC card is partially varied by up data. It is implemented by binary phase shift keying (BPSK) or the like using sub carriers. Similarly to the down communication data, the up communication data is coded by NRZ-L or the like.

The semiconductor integrated circuit device embedded in an IC card receives high-frequency signals supplied from a reader-writer device by an antenna coil provided in the IC card. It rectifies and smooths high-frequency signals produced at both the ends of the antenna coil to form internal voltage required for the operation of its internal circuit. For this reason, power the coil can receive largely varies depending on the resonance frequency of a resonance circuit formed by the antenna coil and this has significant influence on characteristics such as communication distance.

For example, when there are multiple IC cards in a range within which a reader-writer device can communicate, the following takes place: the coils provided in the individual IC cards are influenced by each other and the inductance and the like of the coil provided in each IC card is equivalently increased. This changes the resonance frequency of the resonance circuit formed by each coil to a lower frequency as compared with cases where an IC card is singularly used. As a result, power supplied to each IC card is reduced and the communication distance is significantly shortened. As IC cards are brought closer to each other, especially, the mutual interference is increased and variation in resonance frequency is increased.

As systems using this IC card, those described in Patent Document 1 and Patent Document 2 are known. In these systems, the mutual influence between the coils respectively provided in multiple IC cards is reduced by devising the shape of the coil provided in each IC card. When multiple IC cards are simultaneously used, degradation in characteristics is thereby suppressed.

Patent Document 1 discloses a technology in which the coil provided in each IC card is arranged to be tilted to the housing of the card. Thus even when multiple IC cards are stacked with any orientation, significant variation in resonance frequency is avoided and fluctuation in communication distance that differs depending on the orientation with which IC cards are stacked is reduced.

Patent Document 2 discloses a technology in which the mutual interference between coils is suppressed to ensure a sufficient communication distance by taking the following measure: the base material of each RFID tag in which a coil is formed is folded back and is so arranged that it encircles one side of a magnetic core formed of a soft magnetic member or the like.

### PRIOR ART DOCUMENTS

### Patent Document

[Patent Document 1] Japanese Unexamined Patent Publication No. 2000-137777
[Patent Document 2] Japanese Unexamined Patent Publication No. 2005-33461

### Non-Patent Document

[Non-patent Document 1] ISO/IEC-18092 212 kbps and 424 kbps
[Non-patent Document 2] ISO/IEC-14443

### SUMMARY OF THE INVENTION

When multiple IC cards are simultaneously used, as mentioned above, the resonance frequency of the resonance circuit formed by the coil provided in each IC card is varied by the mutual interference between the coils and this significantly varies characteristics such as communication distance.

To cope with this, the range of fluctuation in mutual interference between coils that is caused depending on the orientation with which the IC cards are stacked can be suppressed by applying the technology disclosed in Patent Document 1. However, the mutual interference itself between coils provided in the individual IC cards cannot be suppressed; therefore, it is necessary to set the resonance frequency of the resonance circuit formed by the antenna coil in each IC card to a frequency significantly higher than the carrier frequency.

When the resonance frequency of the resonance circuit formed by the antenna coil provided in each IC card is set to a frequency significantly higher than the carrier frequency, as mentioned above, a problem arises. When data communication is carried out between one IC card and a reader-writer device in this state, signals close to the carrier frequency are attenuated more than signals close to the resonance frequency of the resonance circuit formed by each antenna coil are. This emphasizes the harmonic components of data signals communicated between the IC card and the reader-writer device and overshoot or undershoot occurs at a point of variation in the amplitude of data signals superimposed on carrier wave signals or the like. As a result, the data signal waveform is disturbed and erroneous data reception occurs at the reader-writer device or the IC card. This impairs the stability of data communication.

Mutual interference between the coils provided in IC cards can be reduced by applying the technology disclosed in Patent Document 2. This makes it possible to bring the resonance frequency of the resonance circuit formed by each antenna coil close to the carrier frequency. However, since it is necessary to fold back a base material with a coil formed therein and encircle one side of a magnetic core formed of a soft magnetic member or the like with it, it is difficult to reduce the thickness of the IC card.

It is an object of the invention to provide a non-contact electronic device that makes it possible to suppress variation in resonance frequency due to mutual interference between the coils provided in individual IC cards and facilitates reduction of the thickness of a housing.

It is another object of the invention to provide a non-contact electronic device that makes it possible to prevent significant degradation in communication distance when multiple IC cards are simultaneously used and facilitates reduction of the thickness of a housing.

The above and other objects and novel features of the invention will be apparent from the description in this specification and the accompanying drawings.

The following is a brief description of the gist of the representative elements of the invention laid open in this application:

The non-contact electronic device of the invention includes: a substrate; a first coil for antenna arranged in the substrate; a semiconductor integrated circuit device that is arranged in the substrate and carries out non-contact interface with an external source utilizing the first coil; and a second coil that comprises a resonance circuit together with the first coil and is shielded from external electromagnetic waves. For example, when there are multiple non-contact electronic devices mentioned above in a range within which a reader-writer device can communicate, the second coils provided in the individual non-contact electronic devices are not mutually influenced by each other. Therefore, even though the inductance or the like of each non-contact electronic device is equivalently increased, the influence of the second coil can be excluded. This makes it possible to ease a situation in which the resonance frequency of the resonance circuit formed by the coils of each non-contact electronic device is varied to a significantly low frequency as compared with cases where a non-contact electronic device is singularly used. With respect to the second coil, it only has to be shielded from external electromagnetic waves and it is unnecessary to provide a means for folding back a base material with a resonance coil formed therein and encircling one side of a magnetic core formed of a soft magnetic member or the like with it.

The following is a brief description of the gist of the effect obtained by the representative elements of the invention laid open in this application:

Even when multiple non-contact electronic devices are simultaneously used, it is possible to suppress variation in resonance frequency due to mutual interference between coils provided in individual non-contact electronic devices. As a result, the resonance frequency of the resonance circuit formed by each antenna coil can be brought close to the carrier frequency. Therefore, it is possible to achieve stable data communication without significant degradation in communication distance and reduce the thickness of the housing of each non-contact electronic device.

### BRIEF DESCRIPTION OF THE DRAWINGS

FIG. 1 is a block diagram illustrating an example of the basic configuration of an IC card as an example of the non-contact electronic device of the invention;

FIG. 2 is an explanatory drawing illustrating an example of the arrangement of the IC cards of the invention illustrated in FIG. 1 and a reader-writer device;

FIG. 3 is a plan view illustrating the structure of the IC card of the invention illustrated in FIG. 1;

FIG. 4 is a plan view illustrating a second example of the IC card;

FIG. 5(A) is an explanatory drawing illustrating the planar configuration of a third example of the IC card;

FIG. 5(B) is a sectional view taken along line X-Y of FIG. 5(A);

FIG. 6 is an explanatory drawing illustrating an example of a situation in which two IC cards illustrated in FIGS. 5(A) and 5(B) are used in proximity to each other in the form of cross section structure;

FIG. 7(A) is an explanatory drawing illustrating the planar configuration of a fourth example of the IC card;

FIG. 7(B) is a sectional view taken along line X-Y of FIG. 7(A);

FIG. 8 is a plan view illustrating an example of the IC card in a fifth embodiment; and

FIG. 9 is a circuit diagram explaining the action of suppressing variation in resonance frequency.

### DETAILED DESCRIPTION OF THE PREFERRED EMBODIMENTS

### 1. Summary of the Preferred Embodiments

First, description will be given to the outline of representative embodiments laid open in this application. The parenthesized reference codes in the drawings referred to in the description of the outline of the representative embodiments just indicate what is contained in the concept of constituent elements to which the codes are affixed as examples.

(1) The non-contact electronic device of the invention includes: a substrate; a first coil (L1) for antenna arranged in the substrate; a semiconductor integrated circuit device (B2) that is arranged in the substrate and carries out non-contact interface with an external source utilizing the first coil; and a second coil (L2) that comprises a resonance circuit together with the first coil and is shielded from external electromagnetic waves. When there are multiple non-contact electronic devices mentioned above in a range within which a reader-writer device can communicate, the second coils provided in the individual non-contact electronic devices are not mutually influenced by each other. Therefore, even though the inductance or the like of each non-contact electronic device is equivalently increased, the influence of the second coil can be excluded. This makes it possible to ease a situation in which the resonance frequency of the resonance circuit formed by the coils of each non-contact electronic device is varied to a significantly low frequency as compared with cases where a non-contact electronic device is singularly used. With respect to the second coil, it only has to be shielded from external electromagnetic waves and it is unnecessary to provide a means for folding back a base material with a resonance coil formed therein and encircling one side of a magnetic core formed of a soft magnetic member or the like with it.

(2) In the non-contact electronic device in Section 1 above, the first coil is a spiral coil formed by a wiring layer of the substrate.

(3) In the non-contact electronic device in Section 1 above, the second coil is a chip inductor arranged in the substrate.

(4) In the non-contact electronic device in Section 1 above, the second coil is a spiral coil formed by a wiring layer of the substrate. In a place where an opening of the spiral coil is covered, there is a metal pattern formed by another wiring layer of the substrate.

(5) In the non-contact electronic device in Section 4 above, the second coil is arranged biased from the vertical and horizontal center lines of the substrate. As a result, the following is implemented just by providing a metal pattern only on either side: even though two non-contact electronic devices are stacked together with their sides without the metal pattern arranged face to face, the positions of the second coils are shifted by themselves; therefore, electromagnetic interference between them can be avoided.

(6) In the non-contact electronic device in Section 1 above, the second coil is a coil formed by a wiring layer provided in the semiconductor integrated circuit device.

(7) In the non-contact electronic device in Section 1 above, the second coil and the semiconductor integrated circuit device are module devices molded with resin.

(8) The non-contact electronic device in Section 1 above is configured as, for example, an IC card or an RFID module.

### 2. Further Detailed Description of the Preferred Embodiments

Further detailed description will be given to the embodiments. Hereafter, detailed description will be given to modes for carrying out the invention with reference to the drawings. In all the drawings for explaining the modes for carrying out the invention, elements having the same functions will be marked with the same reference codes and the repetitive description thereof will be omitted.

### First Embodiment

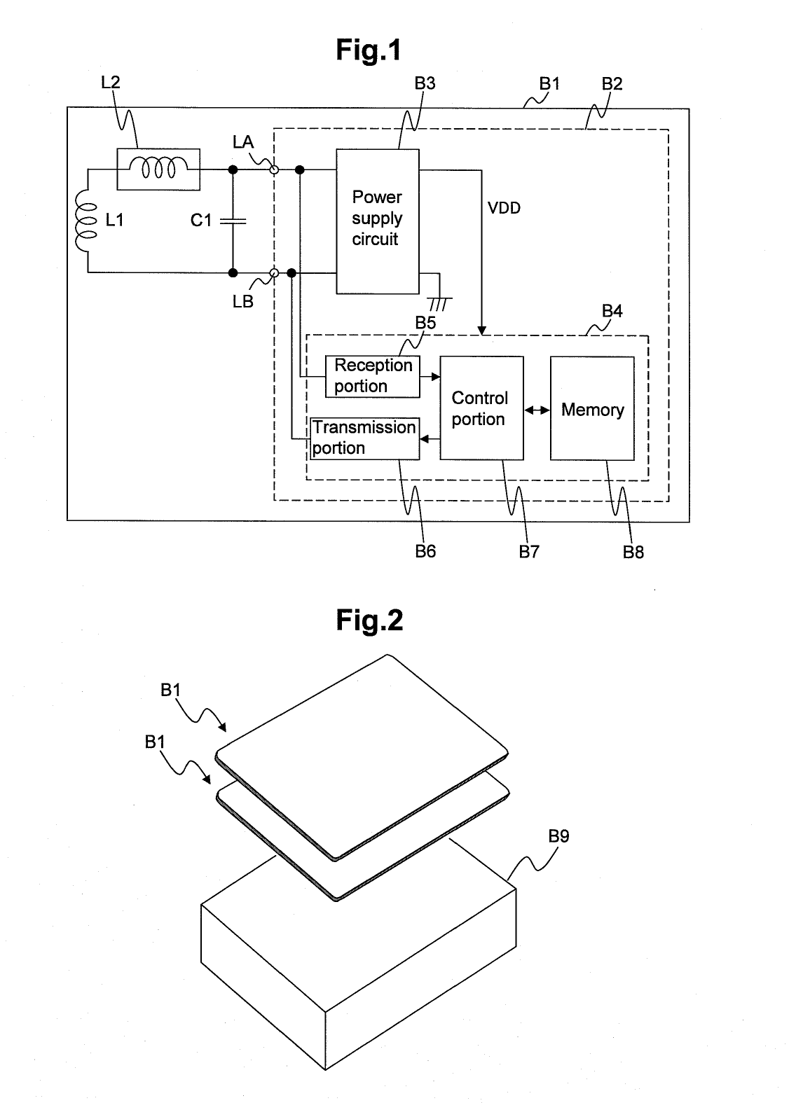

FIG. 1 illustrates the basic configuration of an IC card as an example of the non-contact electronic device of the invention. In FIG. 1, reference code B1 denotes an IC card; L1 denotes an antenna coil provided in the IC card B1; L2 denotes a coil provided in the IC card B1 and shielded from external electromagnetic waves; C1 denotes a resonance capacitor; and B2 denotes a semiconductor integrated circuit device. The semiconductor integrated circuit device B2 includes: a power supply circuit B3, an internal circuit B4, and antenna terminals LA and LB to which the resonance circuit formed by the antenna coil and the like is coupled. In the example in FIG. 1, the resonance capacitor C1 is provided in the IC card B1. Instead, it may be provided in the semiconductor integrated circuit device B2 or may be divided and provided in the IC card B1 and the semiconductor integrated circuit device B2. In the example in FIG. 1, the coil L2 shielded from electromagnetic waves is comprised of a chip inductor magnetically shielded by, for example, ferrite or the like.

The power supply circuit B3 in FIG. 1 is comprised of a rectifying circuit and a smoothing capacitor both of which are omitted from the drawing. The rectifying circuit rectifies and smooths alternating-current signals received by the antenna coil L1 provided in the IC card B1 to obtain power supply voltage VDD supplied as the operating voltage of the internal circuit B4. There may be provided a regulator circuit that carries out control so as to prevent the power supply voltage VDD from becoming equal to or higher than a predetermined voltage. The internal circuit B4 is comprised of a reception portion B5, a transmission portion B6, a control portion B7, and a memory B8. The reception portion B5 demodulates data signals superimposed on alternating-current signals received by the antenna coil L1 provided in the IC card and supplies them as digital information signals to the control portion B7. The transmission portion B6 receives digital data signals outputted from the control portion B7 and modulates alternating-current signals received by the antenna coil L1 with the data signals.

The invention is typically applied to non-contact IC cards that do not have external input/output terminals in their surfaces. Needless to add, the invention may also be used for dual-type IC cards having a non-contact interface and terminals for input/output. Though not specially limited, the semiconductor integrated circuit device B2 in the drawing is formed over a single semiconductor substrate of single crystal silicon or the like by a publicly known processing technology for semiconductor integrated circuits.

FIG. 2 illustrates an example of the arrangement of the IC cards of the invention illustrated in FIG. 1 and a reader-writer device. The antenna coil B1 provided in each IC card B1 receives electromagnetic waves from the reader-writer device B9 and outputs high-frequency alternating-current signals to between the antenna terminals. At this time, the alternating-current signals are partially modulated by data signals. Each the IC card 31 carries out the above operation utilizing high-frequency alternating-current signals outputted from the reader-writer device B9 and thereby communicates data between it and the reader-writer device B9.

Also when there are multiple IC cards in the range within which it can communicate, as illustrated in FIG. 2, the reader-writer device B9 outputs the same electromagnetic waves and communicates data with the IC cards. The reader-writer device can thereby grasp the number of the present IC cards and communicate individual pieces of data between it and each IC card.

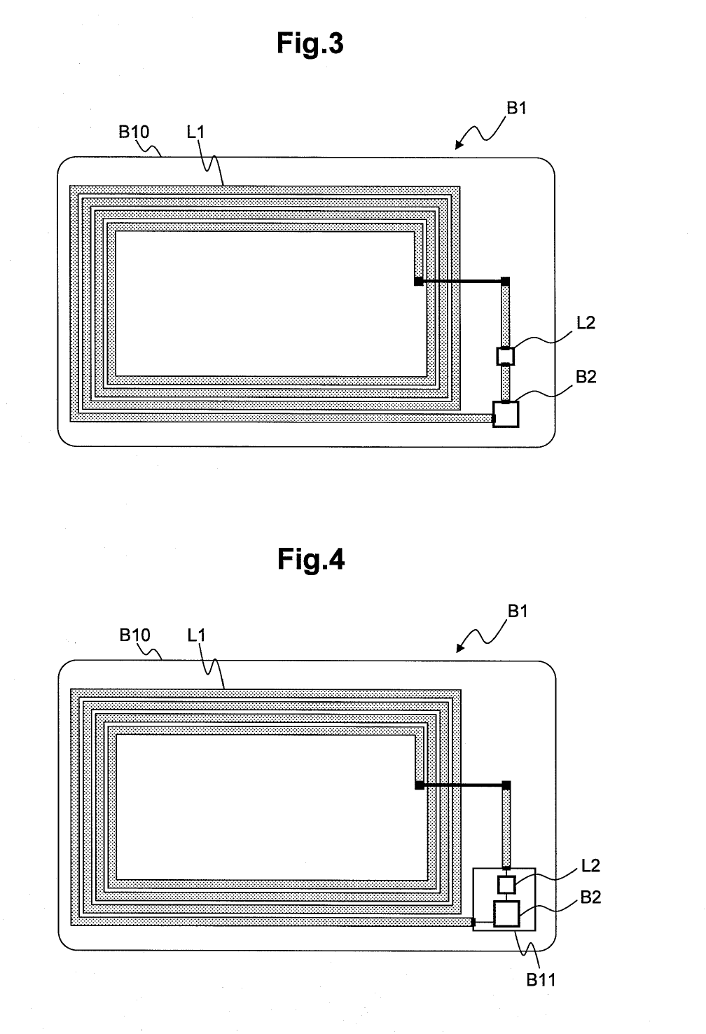

FIG. 3 illustrates the structure of the IC card of the invention illustrated in FIG. 1. The IC card B1 has its shape formed by a resin molded printed wiring board B10. The antenna coil L1 that receives electromagnetic waves from an external reader-writer device B9 is comprised of a spiral coil formed of a wiring of the printed wiring board B10. The semiconductor integrated circuit device B2 is comprised of an IC chip and is embedded in the printed wiring board B10. The coil L2 shielded from external electromagnetic waves is also embedded in the printed wiring board B10 and is coupled to a spiral coil forming the antenna coil L1 as is coupled in series with the IC chip forming the semiconductor integrated circuit device B2.

In FIG. 3, the resonance capacitor C1 is not shown for the sake of simplification of explanation. However, the resonance capacitor C1 is provided in the printed wiring board B10 forming the IC card B1 or the semiconductor integrated circuit device B2 as required.

As the result of the above configuration, a resonance circuit comprised of the antenna coil L1, the coil L2 shielded from external electromagnetic waves, and the resonance capacitor C1 is formed in the IC card B1. Its resonance frequency is determined by the sum of the inductances of the antenna coil L1 and the coil L2 and the resonance capacitor C1.

Since the antenna coil L1 is a coil that receives electromagnetic waves outputted from a reader-writer device, the following takes place at this time: the inductance of the antenna coil L1 is varied by mutual interference with the antenna coil provided in a different IC card as mentioned above.

Meanwhile, the coil L2 is shielded from external electromagnetic waves. Therefore, mutual interference with the coil provided in the different IC card is minimized and variation in inductance due to mutual interference is extremely reduced.

Because of the foregoing, the following takes place in the resonance circuit formed by the antenna coil L1, coil L2, and resonance capacitor C1: the amount of variation in the inductance of the antenna coil L1 caused by mutual interference between it and the antenna coil provided in the different IC card is suppressed to a very low ratio to the following sum: the sum of the inductances of the antenna coil L1 and the coil L2. That is, it is possible to reduce variation in the resonance frequency of the resonance circuit formed by the antenna coil L1, coil L2, and resonance capacitor C1.

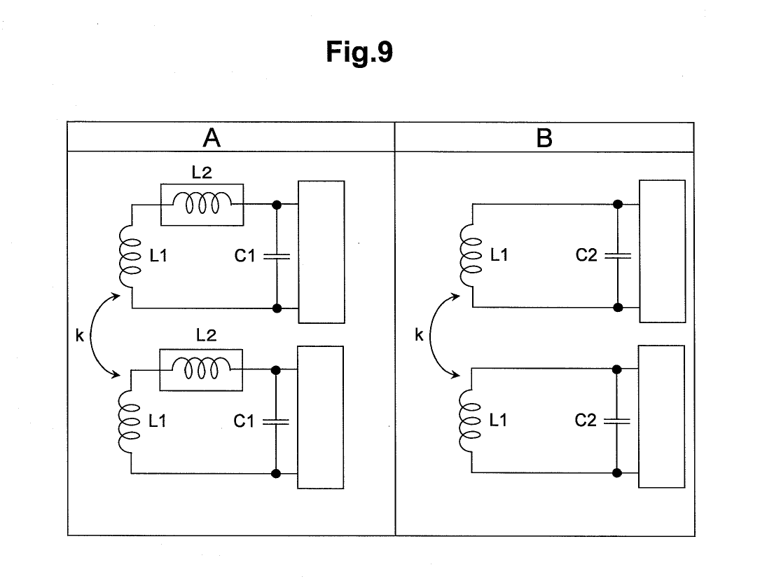

Detailed description will be given to the above action of suppressing variation in resonance frequency with reference to FIG. 9. A in FIG. 9 schematically illustrates a situation in which the resonance circuits of two IC cards B1 receive electromagnetic waves from a reader-writer device B9. B in FIG. 9 schematically illustrates a situation that arises when each resonance circuit is comprised of a coil L1 not magnetically shielded and a capacitor as a comparative example. When k is taken as the coupling coefficient of both the resonance circuits, the resonance frequency f in B in FIG. 9 is expressed as follows:

$$\begin{matrix}f = 1 / 2 π √ \{ ( 1 + k ) L 1 \cdot C 2 \} \\ = 1 / 2 π √ \{ L 1 \cdot C 2 + k L 1 \cdot C 2 \}\end{matrix}$$

At this time, attention is paid to kL1·C2 as a frequency variation component due to interference. When fv is taken as its variation ratio,

fv=kL1·C2/L1·C2=k (1)

Meanwhile, the resonance frequency f in A in FIG. 9 is expressed as follows:

$$\begin{matrix}f = 1 / 2 π √ [ \{ ( 1 + k ) L 1 + L 2 \} C 1 ] \\ = 1 / 2 π √ \{ ( 1 + k ) L 1 \cdot C 1 + L 2 \cdot C 1 \} \\ = 1 / 2 π √ \{ ( L 1 \cdot C 1 + k \cdot L 1 \cdot C 1 + L 2 \cdot C 1 \}\end{matrix}$$

At this time, attention is paid to kL1·C2 as a frequency variation component due to interference. When fv is taken as its variation ratio,

fv=kL1·C1/(L1+L2)C1=k·{L1/(L1+L2)} (2)

According to Expression (1) and Expression (2), k>k·{L1/(L1+L2)}

Hence, variation in resonance frequency can be reduced by magnetically shielding some inductor.

Therefore, it is possible to bring the resonance frequency of the resonance circuit provided in each IC card B1 close to the frequency of carrier wave signals. As a result, it is possible to suppress distortion in data waveform due to emphasis on the higher harmonic waves of data signals as mentioned above and the stability of communication with the reader-writer device B9 is enhanced. Further, even when multiple IC cards are simultaneously used, degradation in communication distance can be minimized. To obtain the above effect, the coil L2 only has to be shielded from electromagnetic waves and the thickness of the housing of the IC card B1 can be reduced without the following need: need for providing a means for folding back a base material with a resonance coil formed therein and encircling one side of a magnetic core formed of a soft magnetic member or the like with it.

### Second Embodiment

FIG. 4 illustrates a second example of the IC card. The IC card B1 illustrated in FIG. 4 has its card shape formed by a resin molded printed wiring board. The antenna coil L1 that receives electromagnetic waves from an external reader-writer device is comprised of a spiral coil formed of a wiring of the printed wiring board B10. The semiconductor integrated circuit device B2 and the coil L2 shielded from external electromagnetic waves are each comprised of an IC chip. A resin molded module component B11 in which the semiconductor integrated circuit device B2 and the coil L2 are coupled in series with each other is embedded in the printed wiring board B10 and is coupled to the antenna coil L1.

In FIG. 4, the resonance capacitor C1 is not shown for the sake of simplification of explanation. However, the resonance capacitor C1 is provided in the printed wiring board B10 forming the IC card B1 or the semiconductor integrated circuit device B2 as required.

As the result of the above configuration, a resonance circuit comprised of the antenna coil L1, the coil L2 shielded from external electromagnetic waves, and the resonance capacitor C1 is formed in the IC card B1. Its resonance frequency is determined by the sum of the inductances of the antenna coil L1 and the coil L2 and the resonance capacitor C1.

The antenna coil L1 provided in the IC card B1 receives electromagnetic waves outputted from a reader-writer device and supplies high-frequency signals to the semiconductor integrated circuit device B2 through the coil L2. Therefore, when multiple IC cards B1 are placed in proximity to each other, the antenna coils L1 provided in the individual IC cards B1 interfere with each other. In the resonance circuits formed by the individual antenna coils L1, the antenna coils behave in accordance with their varied inductances.

Meanwhile, since the coil L2 is comprised of an IC chip, it is shielded from external electromagnetic waves. Therefore, the high-frequency signals generated from electromagnetic waves by the coil L2 are very small. Further, since a current produced by electromagnetic waves received by the antenna coil L1 is passed through the coil L2, electromagnetic waves are produced from the coil L2. Since the coil L2 is comprised of an IC chip, however, the electromagnetic waves leaking to the outside are very small. As a result, the coil L2 can suppress mutual interference with the coil provided in a different IC card and variation in the inductance of the coil L2 can be minimized.

Because of the foregoing, the following takes place in the resonance circuit formed by the antenna coil L1, coil L2, and resonance capacitor C1: the amount of variation in the inductance of the antenna coil L1 caused by mutual interference with the antenna coil provided in the different IC card is suppressed to a very low ratio to the following sum: the sum of the inductances of the antenna coil L1 and the coil L2. That is, it is possible to reduce variation in the resonance frequency of the resonance circuit formed by the antenna coil L1, coil L2, and resonance capacitor C1.

This makes it possible to bring the resonance frequency of the resonance circuit provided in the IC card B1 close to the frequency of carrier wave signals. As a result, it is possible to suppress distortion in data waveform due to emphasis on the higher harmonic waves of data signals and the stability of communication with the reader-writer device is enhanced. Further, even when multiple IC cards are simultaneously used, degradation in communication distance can be minimized. In addition, the coil L2 can be formed by a publicly known processing technology for IC cards and it is also possible to apply a technology for reducing the thickness of IC cards.

In addition, the coil L2 can be formed by a publicly known processing technology for IC cards and it is possible to apply a technology for reducing the thickness of IC cards. In dual-type IC cards having a non-contact interface and terminals for input/output, the semiconductor integrated circuit device B2 is usually molded with resin to provide the terminals for input/output. For this reason, it is unnecessary to newly add a manufacturing process step for resin molding.

### Third Embodiment

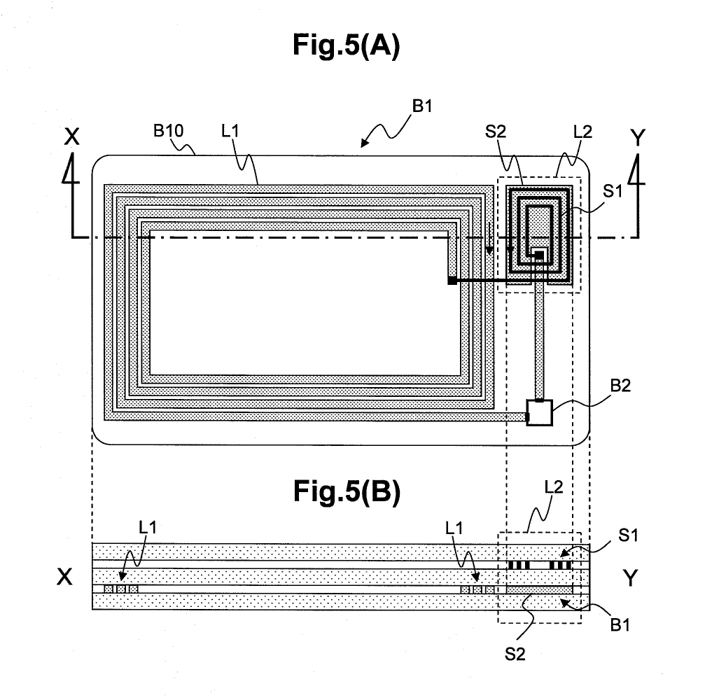

FIG. 5(A) illustrates the planar configuration of a third example of the IC card and FIG. 5(B) shows a sectional view taken along line X-Y of FIG. 5(A). The IC card B1 illustrated in FIGS. 5(A) and 5(B) has its card shape formed by a resin molded printed wiring board. The antenna coil L1 that receives electromagnetic waves from an external reader-writer device is comprised of a spiral coil formed of a wiring of the printed wiring board B10. The coil L2 shielded from external electromagnetic waves is comprised of: a spiral coil S1 formed of a wiring of the printed wiring board B10; and an electromagnetic wave shielding plate S2 formed of a wiring layer different from the wiring layer forming the spiral coil S1. The semiconductor integrated circuit device B2 is comprised of an IC chip and is coupled to the antenna coil L1 as is coupled in series with the coil L2.

In FIG. 5, the resonance capacitor C1 is not shown for the sake of simplification of explanation. However, the resonance capacitor C1 is provided in the printed wiring board B10 forming the IC card B1 or the semiconductor integrated circuit device B2 as required.

Since the spiral coil S1 comprising the coil L2 is shielded from external electromagnetic waves, it is unnecessary to increase the size of an opening for passing through electromagnetic waves. Thus wiring width, wiring interval, and the like may be set independently of the spiral coil forming the antenna coil L1.

Though not specially limited, the electromagnetic wave shielding plate S2 is comprised of a metal plane of gold, copper, or the like. Incase of the dual interface-type IC card having a contact interface together, a gold plate pattern for forming contact interface terminals may also be used for the electromagnetic wave shielding plate S2. It is advisable that the electromagnetic wave shielding plate S2 should be arranged in a position biased from the vertical and horizontal center lines of the printed wiring board B10. This is because when two IC cards B1 are used as are stacked with their front side and rear side mated with each other, the coils L2 can be easily prevented from being opposed to each other on the opposite side of an electromagnetic wave shielding plate S2.

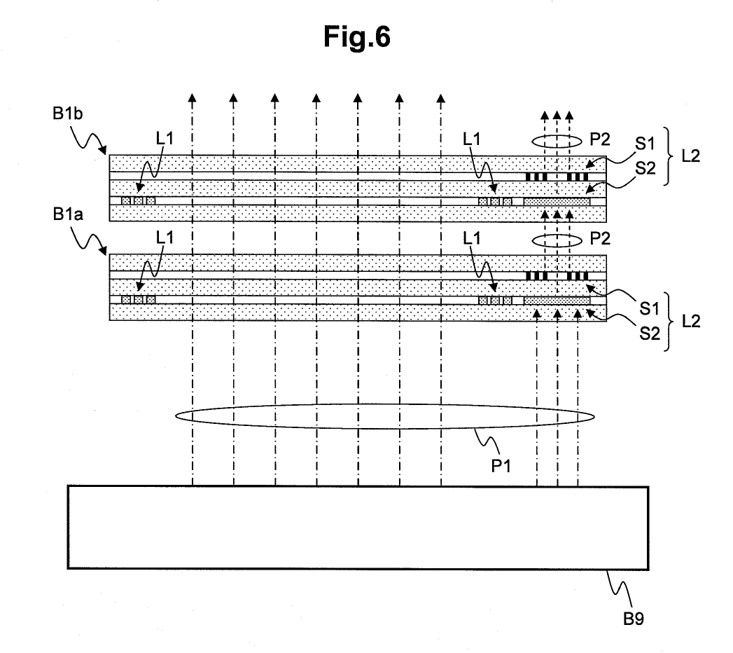

FIG. 6 illustrates an example of a situation in which two IC cards illustrated in FIGS. 5(A) and 5(B) are used in proximity to each other in the form of cross section structure. That is, FIG. 6 shows a situation in which two IC cards B1a and B1b structured as illustrated in FIGS. 5(A) and 5(B) are stacked together and brought close to a reader-writer device B9. The cross section structure of each of the IC cards B1a and B1b is identical with the cross section structure taken along line X-Y of FIG. 5(A), illustrated in FIG. 5(B).

The antenna coils L1 provided in the two IC cards B1a and B1b receive electromagnetic waves P1 outputted from the reader-writer device B9 and supply high-frequency signals to the respective semiconductor integrated circuit devices B2 through the respective coils L2. When the IC cards B1a and B1b are placed in proximity to each other at this time, the antenna coils L1 provided in the individual IC cards interfere with each other. In the resonance circuits formed by the individual antenna coils, for this reason, the antenna coils behave in accordance with their varied inductances.

Meanwhile, since the coil L2 provided in each the IC card is shielded from the electromagnetic waves P1 outputted from the reader-writer device B9 by each the electromagnetic wave shielding plate S2. Therefore, the high-frequency signals generated from electromagnetic waves by the coil L2 provided in each the IC card are very small. Further, since a current produced by electromagnetic waves received by each the antenna coil L1 is passed through each the coil L2, electromagnetic waves P2 are outputted from the coils L2. However, electromagnetic waves are blocked off between the coils L2 provided in the individual IC cards by the electromagnetic wave shielding plate S2 provided in the IC card Bib. Therefore, the coil L2 provided in one IC card is not exposed to electromagnetic waves P2 produced from the coil L2 provided in the other IC card.

As mentioned above, mutual interference between the coils L2 provided in the individual IC cards can be suppressed by providing each the spiral coil S1 with the electromagnetic wave shielding plate S2. Therefore, the amount of variation in their inductances is very small and they operate as coils shielded from external electromagnetic waves. With whatever orientation IC cards are stacked together, the following state can be maintained: a state in which the electromagnetic wave shielding plate S2 provided in either IC card is sandwiched between the spiral coils S1 provided in the individual IC cards; or a state in which the spiral coils S1 are set sufficiently away from each other. For this reason, each the coil L2 operates as a coil shielded form external electromagnetic waves and mutual interference between the coils L2 can be extremely reduced.

Because of the foregoing, the following takes place in the resonance circuit formed by the antenna coil L1, coil L2, and resonance capacitor C1: the amount of variation in the inductance of the antenna coil L1 caused by mutual interference with the antenna coil provided in the different IC card is suppressed to a very low ratio to the following sum: the sum of the inductances of the antenna coil L1 and the coil L2. That is, it is possible to reduce variation in the resonance frequency of the resonance circuit formed by the antenna coil L1, coil L2, and resonance capacitor C1.

This makes it possible to bring the resonance frequency of the resonance circuit provided in the IC card B1 close to the frequency of carrier wave signals. As a result, it is possible to suppress distortion in data waveform due to the above-mentioned emphasis on the higher harmonic waves of data signals and the stability of communication with the reader-writer device is enhanced. Further, even when multiple IC cards are simultaneously used, degradation in communication distance can be minimized. In addition, the antenna coil L1 and the coil L2 can be formed by a publicly known processing technology for IC cards and they are suitable for the application of a technology for reducing the thickness of IC cards.

### Fourth Embodiment

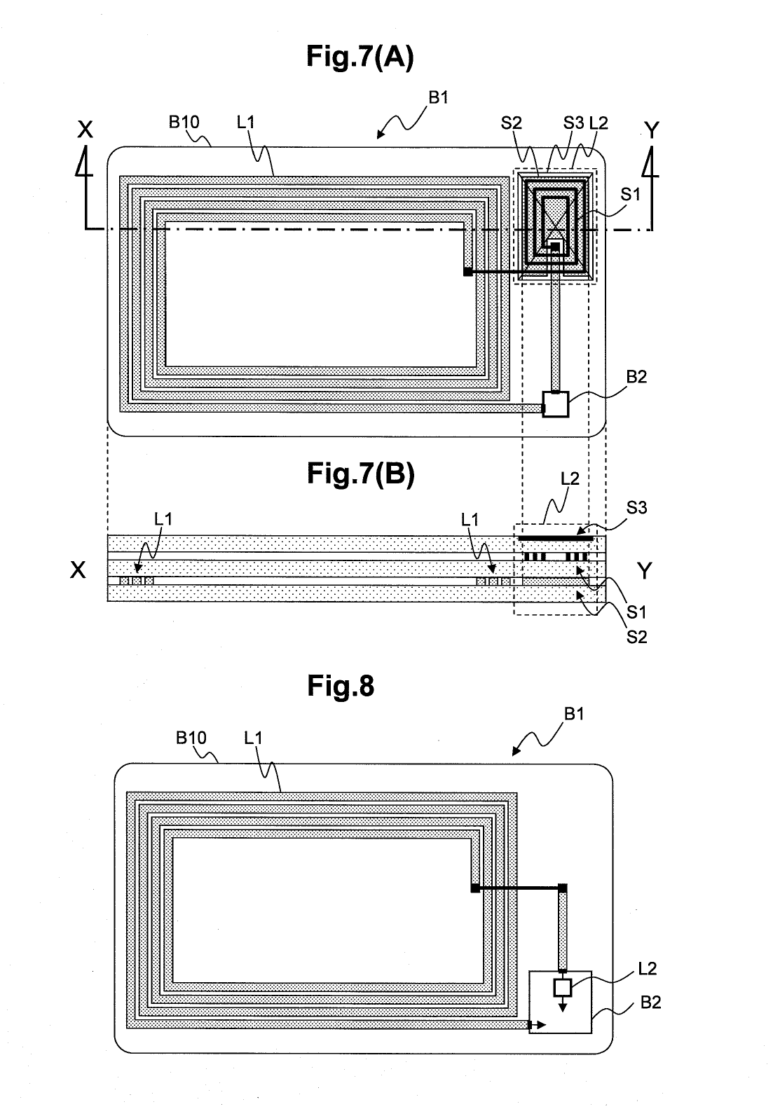

FIG. 7(A) illustrates the planar configuration of a fourth example of the IC card and FIG. 7(B) shows a sectional view taken along line X-Y of FIG. 7(A). The IC card B1 illustrated in FIGS. 7(A) and 7(B) has its card shape formed by a resin molded printed wiring board. The antenna coil L1 that receives electromagnetic waves from an external reader-writer device is comprised of a spiral coil formed of a wiring of the printed wiring board B10. The coil L2 shielded from external electromagnetic waves is comprised of: a spiral coil S1 formed of a wiring of the printed wiring board B10; and an electromagnetic wave shielding plate S2 formed of a wiring layer different from the wiring layer forming the spiral coil S1. The coil L2 is coupled to the antenna coil L1 as is coupled in series with the semiconductor integrated circuit device B2. Further, an electromagnetic wave shielding plate S3 is arranged in a place in the surface of the IC card B1 where electromagnetic waves are blocked off from the spiral coil S1.

In FIG. 7, the resonance capacitor C1 is not shown for the sake of simplification of explanation. However, the resonance capacitor C1 is provided in the printed wiring board B10 forming the IC card B1 or the semiconductor integrated circuit device B2 as required.

As the result of the above configuration, mutual interference between the spiral coil S1 and the spiral coil S1 provided in a different IC card can be suppressed by the electromagnetic wave shielding plates S2 and S3. Therefore, the amount of variation in their inductance is reduced and they operate as coils shielded from external electromagnetic waves. As in the IC card illustrated in FIGS. 5(A) and 5(B), the following state can be maintained with whatever orientation IC cards are stacked together: a state in which an electromagnetic wave shielding plate S2 or S3 is sandwiched between the spiral coils L2 provided in the individual IC cards; or a state in which the spiral coils S1 are arranged sufficiently away from each other. For this reason, each coil L2 operates as a coil shielded from external electromagnetic waves and mutual interference between the coils L2 can be extremely reduced. Especially, the degree of freedom in arranging the coil L2 in the printed wiring board B10 is enhanced as compared with the example illustrated in FIGS. 5(A) and 5(B).

This makes it possible to bring the resonance frequency of the resonance circuit provided in the IC card B1 close to the frequency of carrier wave signals as with the configuration illustrated in FIGS. 5(A) and 5(B). As a result, it is possible to suppress distortion in data waveform due to the above-mentioned emphasis on the higher harmonic waves of data signals and the stability of communication with the reader-writer device is enhanced. Further, even when multiple IC cards are simultaneously used, degradation in communication distance can be minimized. In addition, the antenna coil L1 and the coil L2 can be formed by an ordinary processing technology for IC cards and a publicly known technology for reducing the thickness of IC cards and the like are also applicable thereto.

Further, even at a junction point where the coil L2 and the antenna coil L1 or the coil L2 and the semiconductor integrated circuit device B2 are coupled together, it is possible to shield them from electromagnetic waves outputted from a reader-writer device. The amount of variation in the inductances of the antenna coil L1 and the coil L2 can be further reduced.

### Fifth Embodiment

FIG. 8 illustrates an example of the IC card in a fifth embodiment. The IC card B1 illustrated in FIG. 8 has its card shape formed by a resin molded printed wiring board. The antenna coil L1 that receives electromagnetic waves from an external reader-writer device is comprised of a spiral coil formed of a wiring of the printed wiring board B10. The coil L2 shielded from external electromagnetic waves is formed in part of the semiconductor integrated circuit device B2 utilizing a wiring layer thereof. The coil L1 is coupled to an external terminal of the semiconductor integrated circuit device B2 to which one end of the coil L2 formed in the semiconductor integrated circuit device B2 is coupled. This semiconductor integrated circuit device B2 is embedded in the printed wiring board B10.

In FIG. 8, the resonance capacitor C1 is not shown for the sake of simplification of explanation. However, the resonance capacitor C1 is provided in the printed wiring board B10 forming the IC card B1 or the semiconductor integrated circuit device B2 as required. The coil L2 formed in part of the semiconductor integrated circuit device B2 utilizing a wiring layer thereof has its own electromagnetic waves blocked off by an interlayer protective film or a protective film in the semiconductor integrated circuit device B2 or the package thereof.

As the result of the above configuration, a resonance circuit comprised of the antenna coil L1, the coil L2 shielded from external electromagnetic waves and the resonance capacitor C1 is formed in the IC card B1. Its resonance frequency is determined by the sum of the inductances of the antenna coil L1 and the coil L2 and the resonance capacitor C1.

The antenna coil L1 provided in the IC card B1 receives electromagnetic waves outputted from a reader-writer device and supplies high-frequency signals to the internal circuit of the semiconductor integrated circuit device B2 through the coil L2. Therefore, when multiple IC cards B1 are placed in proximity to each other, the antenna coils L1 provided in the individual IC cards B1 interfere with each other. In the resonance circuits formed by the individual antenna coils L1, the antenna coils behave in accordance with their varied inductances.

Meanwhile, since the coil L2 is embedded in the semiconductor integrated circuit device B2, it is shielded from external electromagnetic waves. Further, since the size of the coil L2 is small, high-frequency signals generated from electromagnetic waves by the coil L2 are very small. Further, since a current produced by electromagnetic waves received by the antenna coil L1 is passed through the coil L2, electromagnetic waves are produced from the coil L2. However, since the coil L2 is embedded in the semiconductor integrated circuit device B2 and is small in size, electromagnetic waves leaking to the outside are very small. As a result, the coil L2 can suppress mutual interference with the coil provided in a different IC card and variation in the inductance of the coil L2 can be minimized.

This also brings the same working-effect as mentioned above. Especially, since the coil L2 is embedded in the semiconductor integrated circuit device B2, the above effect can be obtained without need for complicated wiring in a manufacturing process for IC cards.

Up to this point, concrete description has been given to the invention made by the present inventors based on embodiments.

However, the invention is not limited to the above embodiments and can be variously modified without departing from the subject matter thereof, needless to add. Some examples will be taken. In the example illustrated in FIGS. 5(A) and 5(B), the spiral coil forming the antenna coil L1 and that forming the coil L2 are formed of different wiring layers. Instead, they may be formed of an identical wiring layer and the electromagnetic wave shielding plate S2 may be comprised of a different wiring layer. Even in this case, the same effect can be obtained. Further, a material, such as a radio wave absorbent, which blocks off electromagnetic waves well may be used for the electromagnetic wave shielding plate S2. There are no special limitations on the number of turns, shape, wiring width, wiring intervals, and the like of spiral coils forming the antenna coil L1 and coil L2 shown in FIG. 3 and the following drawings. Even the shape disclosed in Patent Document 1 is also applicable. The degree of shielding the coil L2 from external electromagnetic waves is not limited to absolute shielding and “shielding” naturally means that within an appropriate allowable range.

The invention can be widely utilized for IC cards, IC tags, and the like that are operated by rectifying and smoothing alternating-current voltage received by a coil to form internal voltage.

What is claimed is:

1. Non-contact electronic device comprising:
a substrate;
a first coil for antenna arranged in the substrate;
a semiconductor integrated circuit device arranged in the substrate and carrying out non-contact interface with an external source utilizing the first coil; and
a second coil comprising a resonance circuit together with the first coil and shielded from external electromagnetic waves.

2. The non-contact electronic device according to claim 1,
wherein the first coil is a spiral coil formed of a wiring layer of the substrate.

3. The non-contact electronic device according to claim 1,
wherein the second coil is a chip inductor arranged in the substrate.

4. The non-contact electronic device according to claim 1,
wherein the second coil is a spiral coil formed of a wiring layer of the substrate,
the non-contact electronic device comprising a metal pattern formed of a different wiring layer of the substrate in a place where an opening of the spiral coil is covered.

5. The non-contact electronic device according to claim 4,
wherein the second coil is arranged as is biased from the vertical and horizontal center lines of the substrate.

6. The non-contact electronic device according to claim 1,
wherein the second coil is a coil formed of a wiring layer provided in the semiconductor integrated circuit device.

7. The non-contact electronic device according to claim 1,
wherein the second coil and the semiconductor integrated circuit device are a module device molded with resin.

8. The non-contact electronic device according to claim 1, which is an IC card or an RFID module.
